(19) United States
(12) Patent Application Publication
(10) Pub. No.: US 2025/0126218 A1
(43) Pub. Date: Apr. 17, 2025

(54) SENDING SECURITY DOCUMENT ACCORDING TO SECURITY LEVEL OF MULTIPLE DESTINATIONS

(71) Applicant: Hewlett-Packard Development Company, L.P., Spring, TX (US)

(72) Inventor: Hannam KIM, Seongnam Si (KR)

(21) Appl. No.: 18/682,009

(22) PCT Filed: Jan. 19, 2022
(86) PCT No.: PCT/US2022/012899

§ 371 Date: Feb. 7, 2024

(30) Foreign Application Priority Data
Aug. 9, 2021 (KR) 10-2021-0104780

(51) Int. Cl. H04N 1/44; H04N 1/00; H04N 1/32

(52) U.S. Cl. CPC H04N 1/444; H04N 1/00482; H04N 1/32

(57) ABSTRACT

An example image forming apparatus includes a scanner, a communication unit, a user interface unit, a processor, and a memory to store instructions executable by the processor. The processor is to execute the instructions to obtain information about a plurality of destinations through the user interface unit, generate a scanned document by scanning a document using the scanner, obtain security level information of the scanned document based on security setting information used to detect a security level, generate security documents respectively corresponding to security levels of the plurality of destinations from the scanned document based on the security level information of the scanned document and security level information of the plurality of destinations, and transmit, through the communication unit, the security documents respectively corresponding to the security levels of the plurality of destinations to the plurality of destinations, respectively.

### BACKGROUND

An image forming apparatus may obtain a scanned document by scanning a document. The image forming apparatus may output the scanned document as printed matter or transmit the scanned document to a destination set by a user input. For example, the set destination may be at least one of an e-mail address, a fax number, and a network address.

### BRIEF DESCRIPTION OF THE DRAWINGS

Various examples will be described below by referring to the following figures.

FIG. 1 is a conceptual diagram for explaining an operation of generating and transmitting security documents for respective security levels of a plurality of destinations in an image forming apparatus according to an example.

FIG. 2A is a block diagram illustrating an image forming apparatus according to an example.

FIG. 2B is a block diagram illustrating a processor of an image forming apparatus according to an example.

FIG. 3 is a flowchart illustrating an operating method of an image forming apparatus to generate and transmit security documents for respective security levels of a plurality of destinations according to an example.

FIG. 4 is a view for explaining a security level and security information about the security level according to an example.

FIG. 5 is a view for explaining a screen for setting a user's destination and a user's security level according to an example.

FIGS. 6A to 6C are views for explaining a screen for setting a security level of a scanned document according to an example.

FIG. 7 is a view for explaining a security document generated for each of a plurality of security levels according to an example.

FIG. 8 is a view for explaining a security level set for each of a plurality of users according to an example.

FIG. 9 is a view for explaining destination information of a plurality of users according to an example.

FIG. 10 is a view for explaining a receiving destination according to a security level and job type of a scanned document according to an example.

FIG. 11 is a flowchart illustrating an operating method of components of an image forming apparatus according to an example.

FIG. 12 is a view illustrating instructions stored in a non-transitory computer-readable storage medium according to an example.

### DETAILED DESCRIPTION

Below, a description will be given of examples of the disclosure with reference to the attached drawings. In this regard, the present disclosure may have different forms and should not be construed as being limited to the examples set forth herein.

An “image forming apparatus” may refer to any apparatus capable of performing an image forming job, such as a printer, a copier, a scanner, a fax machine, a multi-function printer (MFP), or a display device. Further, the image forming apparatus may be a two-dimensional (2D) image forming apparatus or a three-dimensional (3D) image forming apparatus. An “image forming job performed by the image forming apparatus” may refer to a job related to printing, copying, scanning, faxing, storing, sending, coating, etc., or a combination of two or more of the above jobs.

“Security setting information” may refer to information used to detect a security level for certain information. For example, the security setting information may include information about a security image or a security keyword used to detect a plurality of security levels. The security level may be classified according to the degree to which security is desired. For example, the higher the degree of security desired, the higher the security level.

“Security level information of a scanned document” may refer to information indicating a security level in which information included in a scanned document is detected according to security setting information. For example, the security level of the scanned document may be set for each page of the scanned document. For example, the security level of the scanned document may be set based on a result of detecting whether the information included in the scanned document is the same as or similar to at least one of a pre-registered security image and a security keyword.

“Security level information of a destination” may refer to information indicating a security level set to a user for a destination. For example, the security level may be set differently for each user. For example, based on user's security levels being different, the type or range of accessible information may be different. For example, the range of information accessible to a user set to a higher security level may be greater than the range of information accessible to a user set to a lower security level.

A “security document” may refer to a document generated from a scanned document based on a security level of a destination. For example, because different user's security levels have different types or ranges of accessible information, security documents generated from scanned documents for users with different security levels may be different from each other.

“Destination information” may refer to information about a destination used to transmit a certain document to a user. For example, the destination information may include at least one of scan-to-network, e-mail, scan-to-share, fax, scan-to-storage information, and the like.

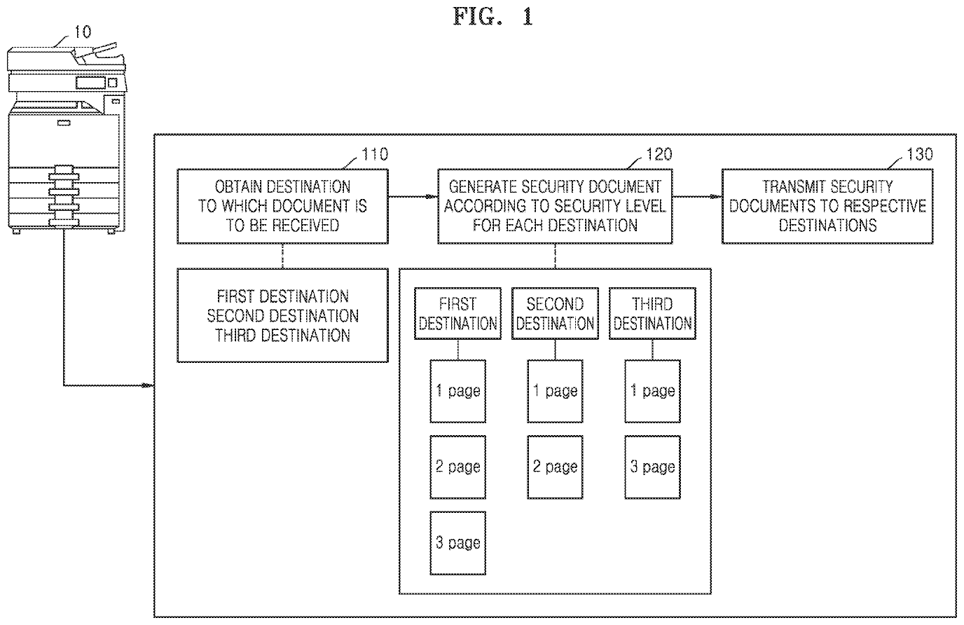

FIG. 1 is a conceptual diagram for explaining an operation of generating and transmitting security documents for respective security levels of a plurality of destinations in an image forming apparatus according to an example.

Referring to FIG. 1, an image forming apparatus 10 may obtain information about a destination to which a document is to be received in operation 110. For example, the image forming apparatus 10 may obtain destination information for a plurality of users. For example, the image forming apparatus 10 may receive, through a user interface unit, information about a first destination for a first user, information about a second destination for a second user, information about a third destination for a third user, and so on.

In operation 120, the image forming apparatus 10 may generate a security document according to a security level for each destination. For example, the range of information that can be disclosed may be different for each of the plurality of users. For example, based on the plurality of users having different work scopes or different work rights, information provided for the same document may be set differently. Accordingly, the image forming apparatus 10 may generate a security document corresponding to each security level of the plurality of users for each destination of the plurality of users.

For example, it may be assumed that a document is composed of three pages, and security levels are classified into level 1, level 2, and level 3, wherein level 1 has a higher security level than level 2 and level 2 has a higher security level than level 3. That is, the closer to level 1, the higher the security level, and the range of accessible information may also be greater than the range of accessible information according to the lower security level. In addition, it is assumed that the security level of the first user is level 1, the security level of the second user is level 2, and the security level of the third user is level 3.

For example, pages of a document accessible to a user with a security level of level 1 may be pages 1, 2, and 3. In addition, pages of a document accessible to a user with a security level of level 2 may be pages 1 and 2. In addition, pages of a document accessible to a user with a security level of level 3 may be pages 1 and 3. The image forming apparatus 10 may generate a security document corresponding to a user's security level. For example, the image forming apparatus 10 may generate a first security document composed of page 1, page 2, and page 3, a second security document composed of page 1 and page 2, and a third security document composed of page 1 and page 3.

In operation 130, the image forming apparatus 10 may transmit the security documents to respective destinations. For example, the image forming apparatus 10 may transmit the first security document according to the information of the first destination, transmit the second security document according to the information of the second destination, and transmit the third security document according to the information of the third destination.

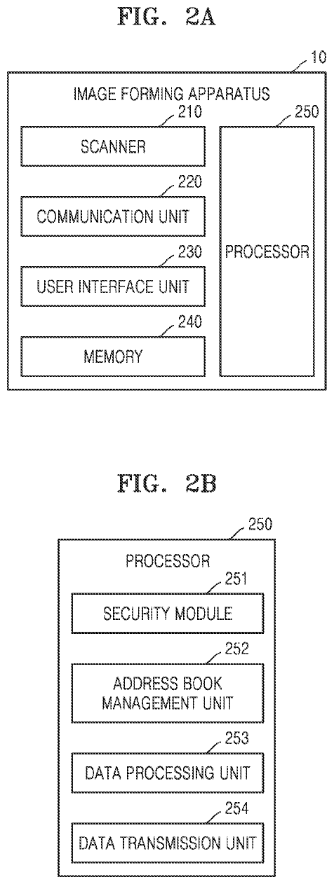

FIG. 2A is a block diagram illustrating an image forming apparatus according to an example.

Referring to FIG. 2A, the image forming apparatus 10 may include a scanner 210, a communication unit 220, a user interface unit 230, a memory 240, and a processor 250. However, the image forming apparatus 10 may include more or fewer elements than the elements shown in the drawings. Hereinafter, examples of the elements will be described.

The scanner 210 may generate a scanned document in which a document is scanned by performing a scan job according to a request for a document scan job in the image forming apparatus 10.

The communication unit 220 may communicate with an external device. As an example, the communication unit 220 may be connected to a network by wire or wirelessly to communicate with an external device. The external device may be an electronic device, a server, or the like.

The communication unit 220 may include a communication module (e.g., a transceiver) supporting one of various wired/wireless communication methods. For example, the communication module may be in the form of a chipset or may be a sticker/barcode (e.g., a sticker including a near field communication (NFC) tag) or the like that includes information for communication. The communication module may be a short-range communication module or a wired communication module.

For example, the communication unit 220 may support at least one of wireless LAN, Wireless Fidelity (Wi-Fi), WI-FI Direct (WFD), Bluetooth, Bluetooth Low Energy (BLE), wired LAN, NFC, Zigbee Infrared Data Association (IrDA), 3G, 4G, 5G, and the like.

The user interface unit 230 may include an input unit to receive, from a user, an input for controlling an operation of the image forming apparatus 10, and an output unit to display information, such as a result of an operation of the image forming apparatus 10 or a state of the image forming apparatus 10. For example, the user interface unit 230 may include an operation panel to receive a user input, a display panel to display a screen, and the like.

As an example, the input unit may include a device for receiving various types of user inputs, such as a keyboard, a physical button, a touch screen, a camera, a microphone, and the like. In addition, the output unit may include, for example, a display panel, a speaker, and the like. However, the disclosure is not limited thereto, and the user interface unit 230 may include a device supporting various inputs and outputs.

The memory 240 may store machine readable instructions, a program, and the like. For example, the memory 240 may obtain a security level of a scanned document obtained by scanning a document, generate security documents for respective security levels of a plurality of destinations based on the security level of the scanned document and security levels of a plurality of destinations, and store instructions for an operating method of the image forming apparatus 10 that transmits the security documents to the plurality of destinations, respectively.

The memory 240 may include at least one type of storage medium from among memory of a flash memory type, a hard disk type, a multimedia card micro type or a card type (e.g., SD or XD memory), random access memory (RAM), static random access memory (SRAM), read-only memory (ROM), electrically erasable programmable ROM (EEPROM), programmable ROM (PROM), magnetic memory, a magnetic disk, an optical disk, and the like.

The processor 250 is to control an operation of the image forming apparatus 10, and may include at least one processor, such as a central processing unit (central processing unit). The processor 250 may include at least one processor specialized for each function or may be an integrated processor.

The processor 250 may execute a program stored in the memory 240, read data or files stored in the memory 240, or store new data or a file in the memory 240. The processor 250, by executing instructions stored in the memory 240, may perform an operation of obtaining a security level of a scanned document obtained by scanning a document, generating security documents for respective security levels of a plurality of destinations based on the security level of the scanned document and security levels of a plurality of destinations, and transmitting the security documents to the plurality of destinations, respectively.

The processor 250 may obtain information about the plurality of destinations. For example, the processor 250 may receive, through the user interface unit 230, information about destinations for a plurality of users to which a certain document will be transmitted. For example, the user interface unit 230 may receive an input for selecting destinations for a plurality of users from a pre-stored address book. For example, the destination information may include at least one of scan-to-network, e-mail, scan-to-share, fax, scan-to-storage information, and the like.

The scanner 210 may generate a scanned document by scanning a document. The processor 250 may perform a scan job for each page of a document through the scanner 210 and obtain a scanned document.

The processor 250 may obtain security level information of the scanned document based on security setting information used to detect a security level.

For example, the processor 250 may compare information included in the scanned document with the security setting information by reading the scanned document. For example, the processor 250 may obtain information included in the scanned document by using an optical character reader (OCR), an intelligent character reader (ICR), and the like. For example, the security setting information may include information about a security image or a security keyword used to detect a plurality of security levels.

For example, the processor 250 may detect whether an image included in the scanned document is the same as or similar to a pre-registered security image. For example, based on the image included in the scanned document being the same as a first security image, the processor 250 may detect a security level of a page including the image in the scanned document as a security level of the first security image.

For example, the processor 250 may detect whether a character included in the scanned document is the same as or similar to a pre-registered security keyword. For example, based on the character included in the scanned document being the same as a first security keyword, the processor 250 may detect a security level of a page including the character in the scanned document as a security level of the first security keyword.

For example, the processor 250 may obtain security level information for each page of the scanned document based on the security setting information. For example, a security level of the scanned document detected for each page may be finally approved based on a user's input.

For example, the user interface unit 230 may receive an input for setting a security level of the scanned document, which is detected according to the security setting information. The processor 250 may set security level information of the scanned document based on the input for setting the security level of the scanned document.

For example, the user interface unit 230 may receive an input for setting at least one level within a higher security level range including the security level of the scanned document. As an example, the user interface unit 230 may display higher security level information including the security level information of the scanned document for each page of the scanned document. The user interface unit 230 may receive an input for selecting at least one security level based on the higher security level information.

The processor 250 may generate security documents respectively corresponding to security levels of a plurality of destinations from the scanned document based on the security level information of the scanned document and security level information of the plurality of destinations.

For example, information about pages constituting security documents generated according to user's security levels for the plurality of destinations may be different.

For example, the processor 250 may generate security documents respectively corresponding to security levels of a plurality of destinations for respective security levels of the plurality of destinations based on a result of comparing the security level information of the scanned document to the security level information of the plurality of destinations.

For example, the processor 250 may generate a security document composed of pages that are allowed according to the security level information of the plurality of destinations from among pages of the scanned document.

The processor 250 may transmit the security documents respectively corresponding to the security levels of the plurality of destinations through the communication unit 220.

For example, the processor 250 may set a plurality of security levels for differentiating information provided according to a security level of a destination. In addition, the processor 250 may register a security image or a security keyword used to detect a plurality of security levels.

For example, the user interface unit 230 may display a user interface for setting at least one destination for a user and a user's security level. The processor 250 may store information about a user's destination in the memory 240 based on information input through the user interface.

The image forming apparatus 10, based on a scanned document generated by a document scan job, may select and provide information accessible within a user's security level by generating security documents for respective security levels of a plurality of users and transmit the security documents to destinations of the plurality of users.

FIG. 2B is a block diagram illustrating a processor of an image forming apparatus according to an example.

Referring to FIG. 2B, the processor 250 may include a security module 251, an address book management unit 252, a data processing unit 253, and a data transmission unit 254. However, the server 20 may include more or fewer elements than the elements shown in FIG. 2B. Hereinafter, examples of the elements will be described.

The security module 251 may set a plurality of security levels for differentiating information provided according to a security level of a destination. The security module 251 may register a security image or a security keyword used to detect a plurality of security levels.

The address book management unit 252 may register a user's address information. For example, the address information may include at least one of a user's name, at least one destination of the user, a user's security level, and the like. The address book management unit 252 may obtain a user's address information and store the user's address information in the memory 240 through the user interface unit 230.

The data processing unit 253 may detect an image corresponding to a security image or a keyword corresponding to a security keyword based on a result of reading a scanned document. The data processing unit 253 may transmit information detected from the scanned document to the security module 251.

The security module 251 may detect security level information of the scanned document. The security module 251 may detect security level information for each page of the scanned document based on the image corresponding to the security image or the keyword corresponding to the security keyword detected from the scanned document.

The security module 251 may obtain the security level information of the scanned document based on an input for setting a security level of the scanned document. The security module 251 may obtain security level information for each page of the scanned document and transmit the security level information to the data processing unit 253.

The data processing unit 253 may obtain transmission information for each security level of a destination. For example, the data processing unit 253 may obtain information about pages constituting a security document for each security level of a destination. The data processing unit 253 may transmit the information about pages constituting a security document for each security level of a destination to the data transmission unit 254.

The data transmission unit 254 may generate a security document based on page information for each of a plurality of destinations. The data transmission unit 254 may transmit the security document to each of the plurality of destinations by controlling the communication unit 220.

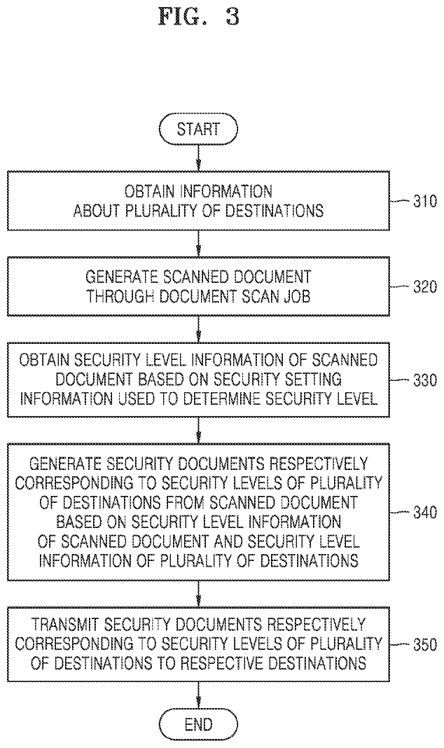

FIG. 3 is a flowchart illustrating an operating method of an image forming apparatus to generate and transmit security documents for respective security levels of a plurality of destinations according to an example.

Referring to FIG. 3, the image forming apparatus 10 may obtain information about a plurality of destinations in operation 310. For example, the image forming apparatus 10 may receive destination information for a plurality of users to which a certain document is to be transmitted. For example, the image forming apparatus 10 may receive an input for selecting destinations for a plurality of users from a pre-stored address book. For example, the destination information may include at least one of scan-to-network, e-mail, scan-to-share, fax, scan-to-storage information, and the like.

In operation 320, the image forming apparatus 10 may generate a scanned document by scanning a document. The image forming apparatus 10 may perform a scan job for each page of a document and generate a scanned document through a scanner.

In operation 330, the image forming apparatus 10 may obtain security level information of the scanned document based on security setting information used to detect a security level.

For example, the image forming apparatus 10 may compare information included in the scanned document with the security setting information by reading the scanned document. For example, the security setting information may include information about a security image or a security keyword used to detect a plurality of security levels.

For example, the image forming apparatus 10 may detect whether an image included in the scanned document is the same as or similar to a pre-registered security image. For example, based on the image included in the scanned document being the same as a first security image, the image forming apparatus 10 may detect a security level of a page including the image in the scanned document as a security level of the first security image.

For example, the image forming apparatus 10 may detect whether a character included in the scanned document is the same as or similar to a pre-registered security keyword. For example, based on the character included in the scanned document being the same as a first security keyword, the image forming apparatus 10 may detect a security level of a page including the character in the scanned document as a security level of the first security keyword.

For example, the image forming apparatus 10 may obtain security level information for each page of the scanned document based on the security setting information. For example, a security level of the scanned document detected for each page may be finally approved based on a user's input.

For example, the image forming apparatus 10 may receive an input for setting a security level of the scanned document, which is detected according to the security setting information. The image forming apparatus 10 may set security level information of the scanned document based on the input for setting the security level of the scanned document.

For example, the image forming apparatus 10 may receive an input for setting at least one level within a higher security level range including the security level of the scanned document. As an example, the image forming apparatus 10 may display higher security level information including the security level information of the scanned document for each page of the scanned document. The image forming apparatus 10 may receive an input for selecting at least one security level based on the higher security level information.

In operation 340, the image forming apparatus 10 may generate security documents respectively corresponding to security levels of a plurality of destinations from the scanned document based on the security level information of the scanned document and security level information of the plurality of destinations.

For example, information about pages constituting security documents generated according to user's security levels for the plurality of destinations may be different.

For example, the image forming apparatus 10 may generate security documents respectively corresponding to security levels of a plurality of destinations for respective security levels of the plurality of destinations based on a result of comparing the security level information of the scanned document to the security level information of the plurality of destinations.

For example, the image forming apparatus 10 may generate a security document composed of pages that are allowed according to the security level information of the plurality of destinations from among pages of the scanned document.

In operation 350, the image forming apparatus 10 may transmit the security documents respectively corresponding to the security levels of the plurality of destinations to respective destinations.

The image forming apparatus 10 may set a plurality of security levels for differentiating information provided according to a security level of a destination. In addition, the image forming apparatus 10 may register a security image or a security keyword used to detect a plurality of security levels.

In addition, the image forming apparatus 10 may display a user interface for setting at least one destination for a user and a user's security level. The image forming apparatus 10 may store information about a user's destination based on information input through the user interface.

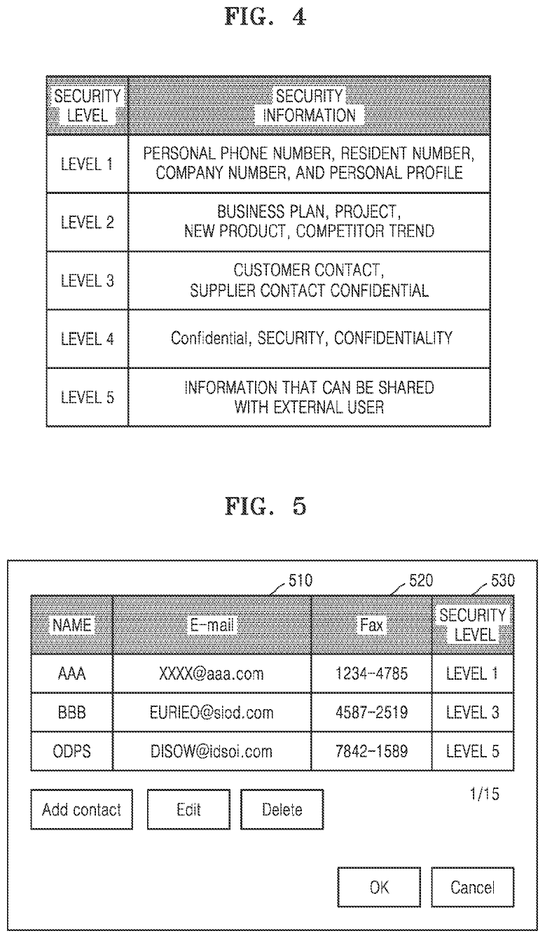

FIG. 4 is a view for explaining a security level and security information about the security level according to an example.

Referring to FIG. 4, the image forming apparatus 10 may provide information differently according to a security level of a destination. Because a work scope or work authority may be different for each user, information accessible to each user may be managed differently. For example, a security level may be classified according to a work scope or work authority. For example, the security level may be classified into five levels as shown in FIG. 4. For example, the security level may be classified into level 1, level 2, level 3, level 4, and level 5. For example, the closer to level 1, the more information that requires security, and the closer to level 5, the greater the range of information that can be disclosed or the range of users that can be disclosed.

For example, level 1 may be a level with the highest security level. For example, security information having a security level of level 1 may be personal information such as a personal phone number, a resident number, a company number, a personal profile, and the like. For example, the security information of which the security level is level 1 may be information that can be shared with a personnel manager.

For example, security information of which the security level is level 2 may be plan information such as a business plan, a project, a new product, a competitor trend, and the like. For example, the security information of which the security level is level 2 may be information that can be shared with a marketing department or the like.

For example, security information of which the security level is level 3 may be contact information such as customer contact information, supplier contact information, and the like. For example, the security information of which the security level is level 3 may be information that can be shared with a strategic planning department, an in-house executive, and the like.

For example, security information of which the security level is level 4 may be security information included in a document in which phrases such as confidential, security, confidentiality, and the like are written. For example, the security information of which the security level is level 4 may be information that can be shared with in-house employees.

For example, security information of which the security level is level 5 may be information that can be shared with an external user.

In FIG. 4, the security level is classified into five levels, but the security level may be classified into more or fewer than five levels.

In addition, the image forming apparatus 10 may register a security image or a security keyword corresponding to each security level. For example, the image forming apparatus 10 may compare information included in a scanned document with a security image or a security keyword. In other words, the image forming apparatus 10 may detect a security level of a scanned document based on a result of detecting whether information included in the scanned document is the same as or similar to a security image or a security keyword.

For example, based on personal information such as personal phone number, resident registration number, company number, personal profile, etc. being detected in the scanned document, the image forming apparatus 10 may detect the security level of the scanned document as level 1. As an example, the image forming apparatus 10 may read the scanned document and detect whether a security image or a security keyword corresponding to personal information is included in the scanned document. Based on the resident registration number being detected in the scanned document, the image forming apparatus 10 may detect the security level of the scanned document as level 1.

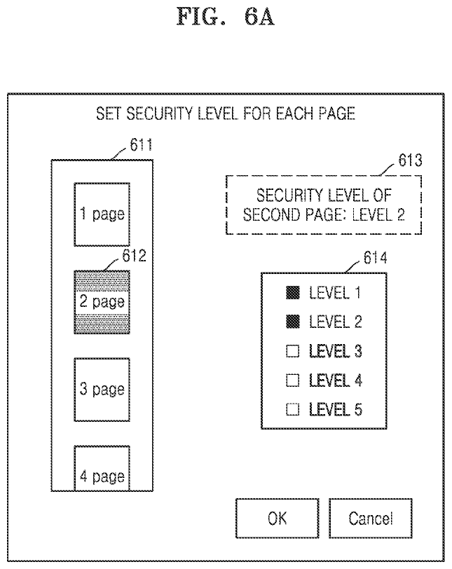

FIG. 5 is a view for explaining a screen for setting a user's destination and a user's security level according to an example.

The image forming apparatus 10 may display a user interface for setting at least one destination for a user and a user's security level. The image forming apparatus 10 may set address information including information of the user's destination and the user's security level based on information input through the user interface.

Referring to FIG. 5, the image forming apparatus 10 may provide a user interface for setting a user's name, a user's at least one destination, and a user's security level. For example, the image forming apparatus 10 may provide an e-mail item 510 and a fax item 520 indicating items of a user's destination. The image forming apparatus 10 may receive information about at least one of the e-mail item 510 and the fax item 520 for a user. For example, the image forming apparatus 10 may provide at least one of a scan-to-network item, a scan-to-share item, a scan-to-storage item, and the like.

For example, the image forming apparatus 10 may display a security level item 530 for setting a user's security level. For example, the user's security level may be set by an input of an administrator. In addition, the user's security level may be set based on at least one of a user's work scope or a user's work authority previously stored in the image forming apparatus 10.

For example, the image forming apparatus 10 may display at least one icon from among an icon for adding a user's address information, an icon for editing the user's address information, and an icon for deleting the user's address information.

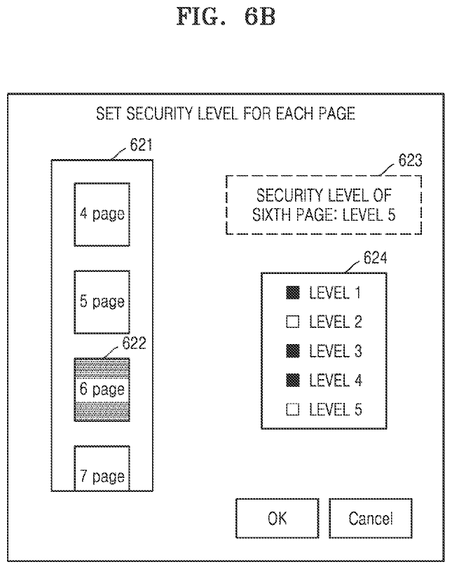

FIGS. 6A to 6C are views for explaining a screen for setting a security level of a scanned document according to an example.

The image forming apparatus 10 may obtain security level information for each page of a scanned document. Because information included for each page of the scanned document may be different, the security level may be different for each page of the scanned document. The image forming apparatus 10 may display security level information detected for each page of the scanned document. The image forming apparatus 10 may receive an input for finally setting a security level for each page of the scanned document. The image forming apparatus 10 may obtain security level information of the scanned document based on an input for finally setting a security level for each page of the scanned document.

Referring to FIG. 6A, the image forming apparatus 10 may display information 611 of pages constituting the scanned document. For example, the image forming apparatus 10 may receive an input for selecting a second page 612 from among pages of the scanned document. The image forming apparatus 10 may display security level information 613 of the second page 612. For example, a security level of the second page 612 may be level 2.

For example, a first security policy may include a policy capable of providing information of a certain page to a user of a higher security level including a security level of the certain page. For example, because the security level of the second page 612 is level 2, providing information of the second page 612 to a user with a security level of level 1 and a user with a security level of level 2 may satisfy the criteria of the first security policy.

For example, the image forming apparatus 10 may display a user interface 614 for setting a security level within a higher security level range including the security level of the second page 612. For example, the image forming apparatus 10 may display the user interface 614 in which levels 1 and 2 are selectable and level 3, level 4, and level 5 are not selectable based on the first security policy. For example, in the user interface 614, icons corresponding to levels 1 and 2 may be displayed in an active state, and icons corresponding to levels 3, 4, and 5 may be displayed in an inactive state. For example, the image forming apparatus 10 may receive an input for selecting levels 1 and 2 through the user interface 614. The image forming apparatus 10 may detect a transmittable security level for the second page 612 as levels 1 and 2. In other words, the image forming apparatus 10 may detect that the second page 612 may be transmitted to users with security levels of levels 1 and 2.

Referring to FIG. 6B, the image forming apparatus 10 may display information 621 of pages constituting a scanned document. For example, the image forming apparatus 10 may receive an input for selecting a sixth page 622 from among pages of the scanned document. The image forming apparatus 10 may display security level information 623 of the sixth page 622. For example, a security level of the sixth page 622 may be level 5.

For example, the first security policy may include a policy capable of providing information of a certain page to a user of a higher security level including a security level of the certain page. For example, because the security level of the sixth page 622 is level 5, it may be allowed to provide information of the sixth page 622 to users with security levels of levels 1, 2, 3, 4, and 5.

For example, the image forming apparatus 10 may display a user interface 624 for setting a security level within a higher security level range including the security level of the sixth page 622. For example, the image forming apparatus 10 may display the user interface 624 for selecting levels 1, 2, 3, 4, and 5 based on the first security policy. For example, the image forming apparatus 10 may receive an input for selecting levels 1, 3, and 4 through the user interface 624. The image forming apparatus 10 may detect a transmittable security level for the sixth page 622 as levels 1, 3, and 4. In other words, the image forming apparatus 10 may detect that the sixth page 622 may be transmitted to users with security levels of levels 1, 3, and 4.

In FIGS. 6A and 6B, an example process of setting a security level of a page of a scanned document based on the first security policy capable of providing information of a certain page to a user of a higher security level including a security level of the certain page has been described. However, referring to FIG. 6C, a process of setting a security level of a page of a scanned document based on a second security policy in which information about a certain page is not limited by a security level of the certain page will be described. For example, based on the second security policy being activated, the first security policy may be inactivated.

For example, the image forming apparatus 10 may control the second security policy to be activated based on an input for selecting the second security policy from among the security policies. Referring to FIG. 6C, the image forming apparatus 10 may display the information 611 of pages constituting a scanned document. For example, the image forming apparatus 10 may receive an input for selecting the second page 612 from among pages of the scanned document. The image forming apparatus 10 may display the security level information 613 of the second page 612. Although a security level of the second page 612 is level 2, the image forming apparatus 10 may display a user interface 631 capable of selecting levels 1 and 2, and also levels 3, 4, and 5 that are lower than level 2.

For example, the image forming apparatus 10 may receive an input for selecting levels 1 and 4 through the user interface 631. The image forming apparatus 10 may detect a transmittable security level for the second page 612 as levels 1 and 4. In other words, the image forming apparatus 10 may detect that the second page 612 may be transmitted to users with security levels of levels 1 and 4.

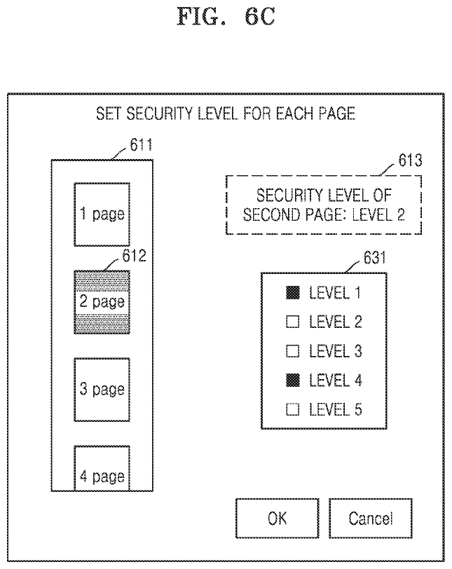

FIG. 7 is a view for explaining a security document generated for each of a plurality of security levels according to an example.

In an example, the image forming apparatus 10 may generate security documents respectively corresponding to security levels of a plurality of destinations for respective security levels of the plurality of destinations based on a result of comparing security level information of a scanned document to security level information of the plurality of destinations. For example, the image forming apparatus 10 may generate a security document composed of pages that are allowed according to the security level information of the plurality of destinations from among pages of the scanned document.

For example, a document may be composed of 7 pages. A scanned document obtained by scanning a document may also be composed of 7 pages. A security level finally set for a second page of the scanned document may be level 1 and level 2, as described with reference to FIG. 6A. In addition, a security level finally set for a sixth page of the scanned document may be levels 1, 3, and 4, as described with reference to FIG. 6B. Security levels finally set for first page, third page, fourth page, fifth page, and seventh page of the scanned document may be level 1 to level 5.

Referring to FIG. 7, a security document 710 that can be transmitted to a user with a security level of level 1 may be composed of first to seventh pages. A security document 720 that can be transmitted to a user with a security level of level 2 may be composed of first to fifth and seventh pages. A security document 730 that can be transmitted to a user with a security level of level 3 may be composed of first and third to seventh pages. A security document 740 that can be transmitted to a user with a security level of level 4 may be composed of first and third to seventh pages. A security document 750 that can be transmitted to a user with a security level of level 5 may be composed of first, third to fifth, and seventh pages.

Accordingly, a user may receive a security document to which a security of a document is applied according to a user's security level.

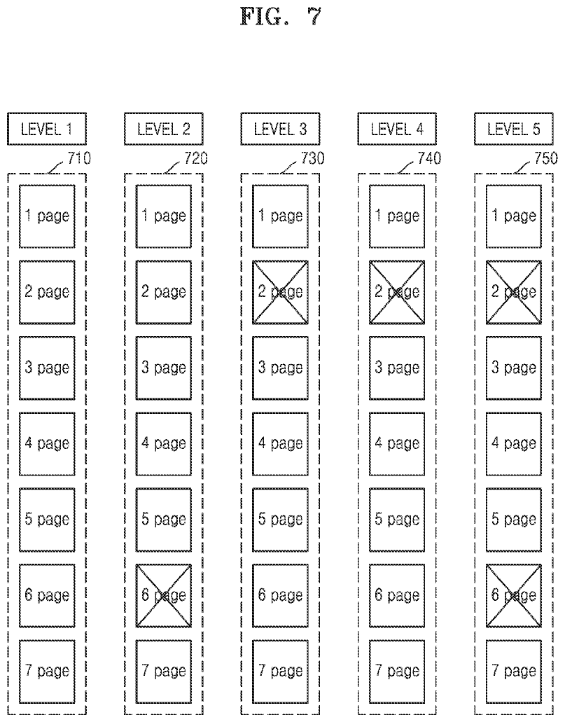

FIG. 8 is a view for explaining a security level set for each of a plurality of users according to an example.

In an example, because each user has a different work scope or work authority, the type and content of accessible information may be set differently for each user. For example, the image forming apparatus 10 may transmit a security document to which security is applied according to a security level of a destination based on performing a document transmission job. For example, the security level may be classified into level 1 to level 5 according to a user's work scope or a user's work authority. In the illustrated example, the user's security level may be set to a certain level from among five levels.

Referring to FIG. 8, a security level of a first user and a fifth user may be set to level 1, a security level of a second user and a fourth user may be set to level 2, a security level of a sixth user may be set to level 3, a security level of a third user and a seventh user may be set to level 4, and a security level of an eighth user to a tenth user may be set to level 5.

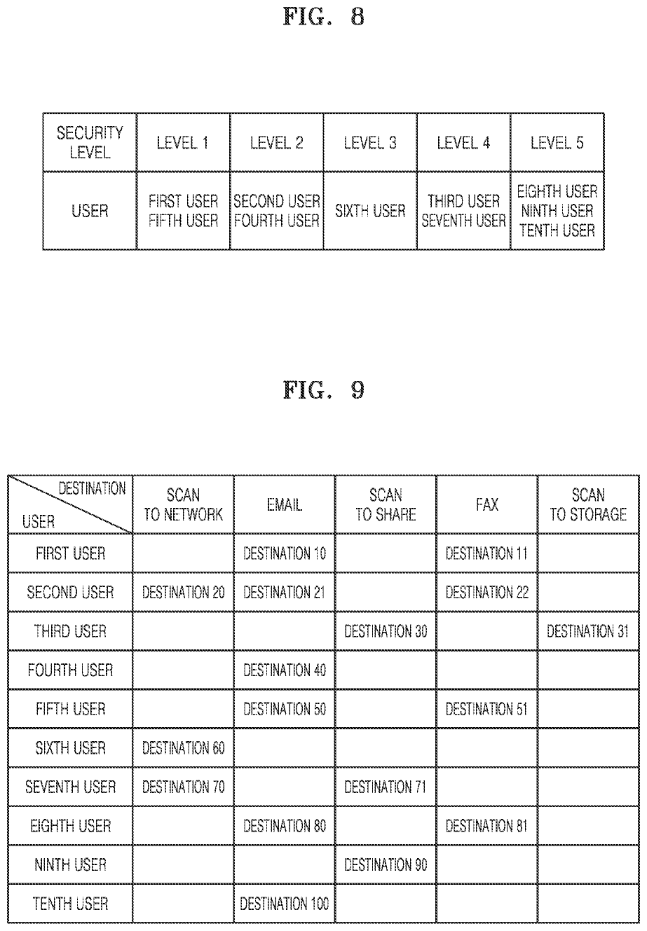

FIG. 9 is a view for explaining destination information of a plurality of users according to an example.

In an example, the image forming apparatus 10 may receive information about at least one destination for a user through a user interface unit. For example, as described in FIG. 5, the image forming apparatus 10 may receive, through a user interface unit, information about a user's name, a user's e-mail, a user's fax, and a user's security level. The image forming apparatus 10 may store at least one destination information for a user.

Referring to FIG. 9, the destination information may include at least one of scan-to-network, e-mail, scan-to-share, fax, and scan-to-storage information. For example, the image forming apparatus 10 may store destination information for an e-mail and a fax of a first user, store destination information for a scan-to-network, an e-mail, and a fax of a second user, store destination information for a scan-to-share and a scan-to-storage of a third user, store destination information for an e-mail of a fourth user, and store destination information for an e-mail and a fax of a fifth user. In addition, the image forming apparatus 10 may store destination information for a scan-to-network of a sixth user, store destination information for a scan-to-network and a scan-to-share of a seventh user, store destination information for an e-mail and a fax of an eighth user, store destination information for a scan-to-share of a ninth user, and store destination information for an e-mail of a tenth user.

The image forming apparatus 10 may transmit a security document to at least one destination selected from among user destinations.

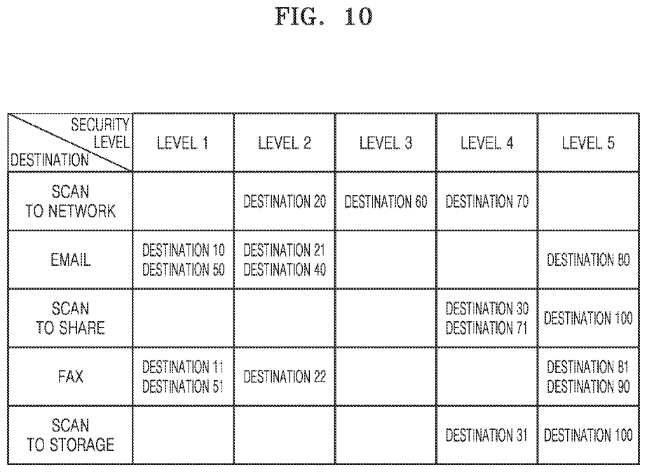

FIG. 10 is a view for explaining a receiving destination according to a security level and job type of a scanned document according to an example.

In an example, the image forming apparatus 10 may generate a security document corresponding to a security level of each destination for each destination. For example, as described in FIG. 7, the image forming apparatus 10 may generate a security document 710 that can be transmitted to a user with a security level of level 1, a security document 720 that can be transmitted to a user with a security level of level 2, a security document 730 that can be transmitted to a user with a security level of level 3, a security document 740 that can be transmitted to a user with a security level of level 4, and a security document 750 that can be transmitted to a user with a security level of level 5.

Referring to FIG. 10, the image forming apparatus 10 may store a receiving destination according to a security level and a job type. For example, as described in FIGS. 8 and 9, the image forming apparatus 10, based on information about a security level and destination set for each of a plurality of users, may store destination information according to the security level and job type.

For example, the image forming apparatus 10 may transmit a security document to a first user and a fifth user with a security level of level 1 based on destination information of an e-mail or fax.

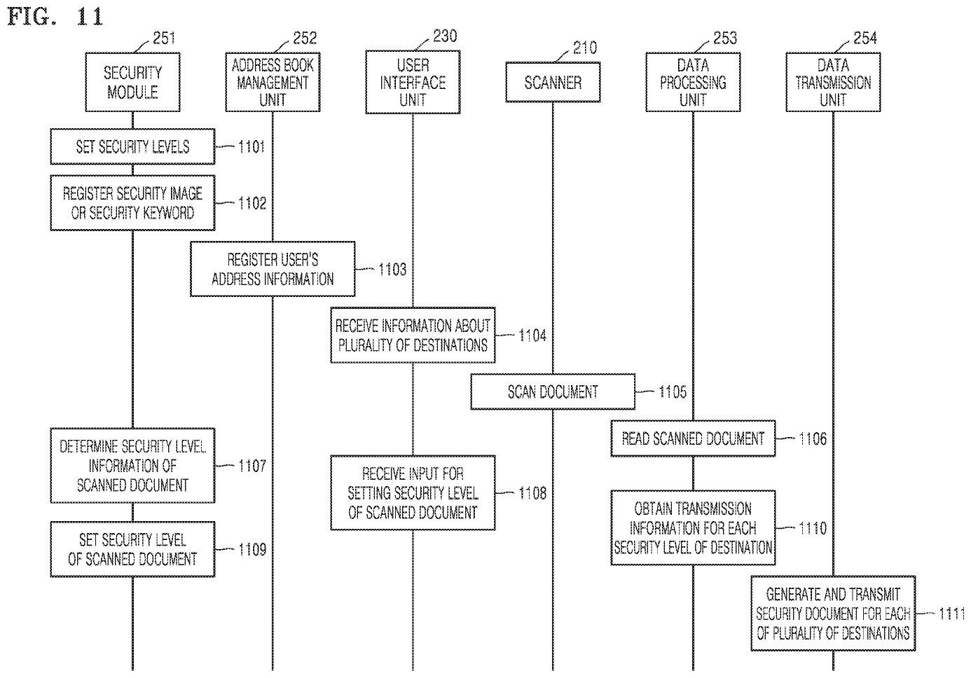

FIG. 11 is a flowchart illustrating an operating method of components of an image forming apparatus according to an example.

Referring to FIG. 11, the security module 251 may set a plurality of security levels for differentiating information provided according to a security level of a destination in operation 1101. In operation 1102, the security module 251 may register a security image or a security keyword used to detect a plurality of security levels.

In operation 1103, the address book management unit 252 may register a user's address information. For example, the address information may include at least one of a user's name, at least one destination of the user, and a user's security level.

In operation 1104, the user interface unit 230 may receive information about a plurality of destinations. The information about the plurality of destinations may be information about destinations to which a scanned document is to be transmitted. For example, the user interface unit 230 may receive information about a destination to which a certain document can be transmitted for each of a plurality of users.

In operation 1105, the scanner 210 may scan a document. The scanner 210 may generate a scanned document through the scan job. In operation 1106, the data processing unit 253 may detect an image corresponding to a security image or a keyword corresponding to a security keyword based on a result of reading the scanned document. The data processing unit 253 may transmit information detected from the scanned document to the security module 251.

In operation 1107, the security module 251 may detect security level information of the scanned document. The security module 251 may detect security level information for each page of the scanned document based on the image corresponding to the security image or the keyword corresponding to the security keyword detected from the scanned document.

In operation 1108, the user interface unit 230 may display the security level information of the scanned document detected by the security module 251. The user interface unit 230 may receive an input for setting a security level of the scanned document. In this case, the user interface unit 230 may receive an input for setting a security level for each page of the scanned document.

In operation 1109, the security module 251 may obtain the security level information of the scanned document based on an input for setting a security level of the scanned document. The security module 251 may obtain security level information for each page of the scanned document and transmit the security level information to the data processing unit 253.

In operation 1110, the data processing unit 253 may obtain transmission information for each security level of a destination. For example, the data processing unit 253 may obtain information about pages constituting a security document for each security level of a destination. The data processing unit 253 may transmit the information about pages constituting a security document for each security level of a destination to the data transmission unit 254.

In operation 1111, the data transmission unit 254 may generate a security document based on page information for each of a plurality of destinations. The data transmission unit 254 may transmit the security document to each of the plurality of destinations by controlling the communication unit 220.

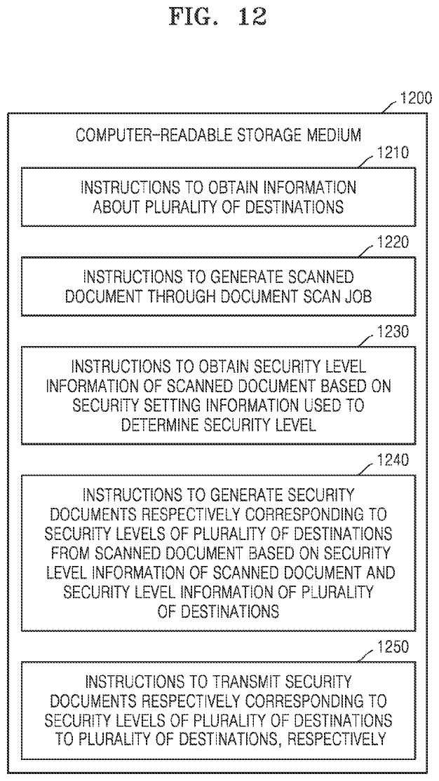

FIG. 12 is a view illustrating instructions stored in a non-transitory computer-readable storage medium according to an example.

A non-transitory computer-readable storage medium 1200 shown in FIG. 12 may obtain a security level of a scanned document obtained by scanning a document, generate security documents for respective security levels of a plurality of destinations based on the security level of the scanned document and security levels of a plurality of destinations, and store instructions for an operating method of the image forming apparatus 10 that transmits the security documents to the plurality of destinations, respectively. For example, the non-transitory computer-readable storage medium 1200 may store instructions 1210 to obtain information about a plurality of destinations, instructions 1220 to generate a scanned document by scanning a document, instructions 1230 to obtain security level information of the scanned document based on security setting information used to detect a security level, instructions 1240 to generate security documents respectively corresponding to security levels of the plurality of destinations from the scanned document based on the security level information of the scanned document and security level information of the plurality of destinations, and instructions 1250 to transmit the security documents respectively corresponding to the security levels of the plurality of destinations to the plurality of destinations, respectively.

The above-described example operating method of the image forming apparatus 10 may be implemented in the form of a non-transitory computer-readable storage medium storing instructions or data executable by a computer or a processor. The examples may be written as computer programs and may be implemented in general-use digital computers that execute programs using the computer-readable recording medium. The computer-readable storage medium may include ROM, RAM, flash memory, CD-ROMs, CD-Rs, CD+Rs, CD-DVD-Rs, DVD-Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, or solid-state disks (SSD), and may be any device capable of storing machine readable instructions, associated data, data files, and data structures, and providing the machine readable instructions, associated data, data files, and data structures to a processor or a computer such that the processor or computer may execute the instructions.

Although examples have been described with reference to the accompanying drawings, various changes and modifications may be made therein. For example, the relevant results may be achieved even based on the described technologies being performed in a different order than the described methods, and/or even based on the described elements such as systems, structures, devices, and circuits being coupled or combined in a different form than the described methods or being replaced or substituted by other elements or equivalents.

It should be understood that examples described herein should be considered in a descriptive sense and not for purposes of limitation. Descriptions of features or aspects within each example should typically be considered as available for other similar features or aspects in other examples. While examples have been described with reference to the figures, it will be understood that various changes in form and details may be made therein without departing from the spirit and scope as defined by the following claims.

What is claimed is:

1. An image forming apparatus comprising:
a scanner;
a communication unit;
a user interface unit;
a processor; and
a memory to store instructions executable by the processor,
wherein the processor, by executing the instructions, is to:
obtain information about a plurality of destinations through the user interface unit,
generate a scanned document by scanning a document using the scanner,
obtain security level information of the scanned document based on security setting information used to detect a security level,
generate security documents respectively corresponding to security levels of the plurality of destinations from the scanned document based on the security level information of the scanned document and security level information of the plurality of destinations, and
transmit, through the communication unit, the security documents respectively corresponding to the security levels of the plurality of destinations to the plurality of destinations, respectively.

2. The image forming apparatus of claim 1, wherein, in a case where the document is composed of a plurality of pages, the processor, by executing the instructions, is to obtain security level information for each page of the scanned document based on the security setting information.

3. The image forming apparatus of claim 1, wherein the processor, by executing the instructions, is to:
receive, through the user interface unit, an input for setting a security level of the scanned document detected according to the security setting information, and
obtain the security level information of the scanned document based on the input for setting a security level of the scanned document.

4. The image forming apparatus of claim 3, wherein the processor, by executing the instructions, is to receive, through the user interface unit, an input for setting at least one security level within a higher security level range including the security level of the scanned document.

5. The image forming apparatus of claim 4, wherein the processor, by executing the instructions, through the user interface unit, is to:
display higher security level information including the security level information of the scanned document for each page of the scanned document, and
receive an input for selecting the at least one security level based on the higher security level information.

6. The image forming apparatus of claim 1, wherein the processor, by executing the instructions, is to generate the security documents respectively corresponding to the security levels of the plurality of destinations for the security levels of the plurality of destinations, respectively, based on a result of comparing the security level information of the scanned document to the security level information of the plurality of destinations.

7. The image forming apparatus of claim 6, wherein the processor, by executing the instructions, is to generate the security document composed of pages that are allowed according to the security level information of the plurality of destinations from among pages of the scanned document.

8. The image forming apparatus of claim 1, wherein the security setting information comprises information about a security image or a security keyword used to detect a plurality of security levels.

9. The image forming apparatus of claim 1, wherein the processor, by executing the instructions, is to:
set a plurality of security levels for differentiating information provided according to a security level of a destination, or
perform at least one of registering a security image or a security keyword used to detect the plurality of security levels.

10. The image forming apparatus of claim 1, wherein the processor, by executing the instructions, is to:
display, through the user interface unit, a user interface for setting at least one destination for a user and a security level of the user, and
store destination information of the user based on information input through the user interface.

11. An operating method of an image forming apparatus, the operating method comprising:
obtaining information about a plurality of destinations;
generating a scanned document by scanning a document;
obtaining security level information of the scanned document based on security setting information used to detect a security level;
generating security documents respectively corresponding to security levels of the plurality of destinations from the scanned document based on the security level information of the scanned document and security level information of the plurality of destinations; and
transmitting the security documents respectively corresponding to the security levels of the plurality of destinations to the plurality of destinations, respectively.

12. The operating method of claim 11, wherein the obtaining of the security level information of the scanned document comprises:
receiving an input for setting a security level of the scanned document detected according to the security setting information; and
obtaining the security level information of the scanned document based on the input for setting the security level of the scanned document.

13. The operating method of claim 12, wherein the receiving of the input for setting the security level of the scanned document comprises receiving an input for setting at least one security level within a higher security level range including a security level corresponding to a page for each page of the scanned document.

14. The operating method of claim 11, wherein the generating of the security documents respectively corresponding to security levels of the plurality of destinations from the scanned document comprises generating the security documents respectively corresponding to the security levels of the plurality of destinations for the security levels of the plurality of destinations, respectively, based on a result of comparing the security level information of the scanned document to the security level information of the plurality of destinations.

15. A non-transitory computer-readable storage medium storing instructions executable by an image forming apparatus, the computer-readable storage medium comprising:
instructions to obtain information about a plurality of destinations;
instructions to generate a scanned document by scanning a document;
instructions to obtain security level information of the scanned document based on security setting information used to detect a security level;
instructions to generate security documents respectively corresponding to security levels of the plurality of destinations from the scanned document based on the security level information of the scanned document and security level information of the plurality of destinations; and
instructions to transmit the security documents respectively corresponding to the security levels of the plurality of destinations to the plurality of destinations, respectively.
